(19) United States
(12) Patent Application Publication
(10) Pub. No.: US 2010/0287470 A1
(43) Pub. Date: Nov. 11, 2010

(54) Information Processing Apparatus and Information Processing Method

(76) Inventors: Fuminori Homma, Tokyo (JP); Tatsushi Nashida, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/772,746

(22) Filed: May 3, 2010

(30) Foreign Application Priority Data
May 11, 2009 (JP) 2009-114196

(51) Int. Cl. G06F 3/01

(52) U.S. Cl. 715/702

(57) ABSTRACT

An information processing apparatus includes: display means for displaying an image; detection means that is disposed in an area other than another area, in which the display means is disposed, for detecting a contact in the area; and control means for recognizing the content of an operation based on a combination of two or more contact positions in which the contact is detected by the detection means and controlling performing of a process corresponding to the content of the operation.

### BACKGROUND OF THE INVENTION

1. Field of the Invention

The present invention relates to an information processing apparatus and an information processing method, and more particularly, to an information processing apparatus and an information processing method capable of implementing a gesture operation without depending on a touch panel.

2. Description of the Related Art

Recently, information processing apparatuses as represented by iPhone (registered trademark of Apple Inc.) in which a user can perform a gesture operation for a touch panel by using a multiple touch method have been widely used. In such information processing apparatuses, a predetermined process (hereinafter, referred to as an interaction process) corresponding to the user's gesture operation is performed (for example, see JP-A-5-100809).

### SUMMARY OF THE INVENTION

However, in order to implement a gesture operation of a multiple touch type, the area of a screen of a touch panel may need to be equal to or greater than a predetermined area. For example, for an information processing apparatus that has a characteristic shape and has a small area of the screen like an information processing apparatus of a wrist-watch type, it is difficult to implement a gesture operation of the multiple touch type on the touch panel. In other words, in order to implement a gesture operation on a touch panel, there may be some limitations on the area of the screen of the touch panel or the shape of the information processing apparatus.

Thus, there is a need for implementing a gesture operation without depending on a touch panel.

According to an embodiment of the present invention, there is provided an information processing apparatus including: display means for displaying an image; detection means that is disposed in an area other than another area, in which the display means is disposed, for detecting a contact in the area; and control means for recognizing the content of an operation based on a combination of two or more contact positions in which the contact is detected by the detection means and controlling performing of a process corresponding to the content of the operation.

In the above-described information processing apparatus, a plurality of the detection means that are disposed in different areas may be included.

In addition, the control means may recognize the area of a contact area, in which the contact is detected, out of the area in which the detection means is disposed and switched between permission of performance and prohibition of performance for control of the recognizing of the content of the operation based on the area.

In addition, the control means may be configured to assume the contact detected by the detection means to be for the purpose of user's gripping the information processing apparatus and control to prohibit the performing of recognizing the content of the operation in a case where the area is equal to or greater than a threshold value, and to assume the contact detected by the detection means to be for the purpose of a user's predetermined operation and control to permit the performing of recognizing the content of the operation for the predetermined operation in a case where the area is smaller than the threshold value.

In addition, the detection means may have an electrostatic sensor that outputs a change in electrostatic capacitance due to a contact and a conductive material that is combined with the electrostatic sensor and has a variable shape.

According to another embodiment of the present invention, there is provided an information processing method corresponding to the above-described information processing apparatus.

In the information processing apparatus and the information processing method according to the embodiments of the present invention, an image is displayed, a contact in an area other than another area in which the image is displayed is detected, and the content of an operation is recognized based on a combination of two or more contact positions in which the contact is detected, and a process corresponding to the content of the operation is controlled to be performed.

As described above, according to the embodiments of the present invention, a gesture operation can be implemented without depending on a touch panel.

### BRIEF DESCRIPTION OF THE DRAWINGS

FIG. 1 is a perspective view showing an external configuration example of a mobile terminal apparatus as an information processing apparatus according to an embodiment of the present invention.

FIG. 2 is a diagram illustrating a detection technique of an electrostatic touch sensor for a touch panel that is used in an electrostatic touch panel.

FIGS. 3A and 3B are diagrams illustrating an example of a gesture operation for a side face of a mobile terminal apparatus and an interaction process corresponding to the gesture operation.

FIG. 4 is a block diagram showing an internal configuration example of the mobile terminal apparatus shown in FIG. 1.

FIG. 5 is a flowchart illustrating an example of a side gesture operation-compliant interaction process.

FIGS. 6A and 6B are diagrams illustrating an incorrect gesture operation detection preventing process.

FIGS. 7A and 7B are diagrams illustrating an incorrect gesture operation detection preventing process.

FIGS. 8A to 8F are diagrams illustrating concrete examples of an interaction process of the mobile terminal apparatus.

FIGS. 9A to 9F are diagrams illustrating concrete examples of an interaction process of the mobile terminal apparatus.

FIGS. 10A and 10B represent an external configuration example of a mobile terminal apparatus as an information processing apparatus according to an embodiment of the present invention and are diagrams showing another example that is different from the example of FIG. 1.

FIG. 11 is an external configuration example of a mobile terminal apparatus as an information processing apparatus according to an embodiment of the present invention and is a diagram showing another example that is different from the examples of FIG. 1 and FIGS. 10A and 10B.

### DESCRIPTION OF THE PREFERRED EMBODIMENTS

Hereinafter, embodiments of the present invention will be described with reference to the accompanying drawings.

### External Configuration Example of Information Processing Apparatus According to Embodiment of Present Invention

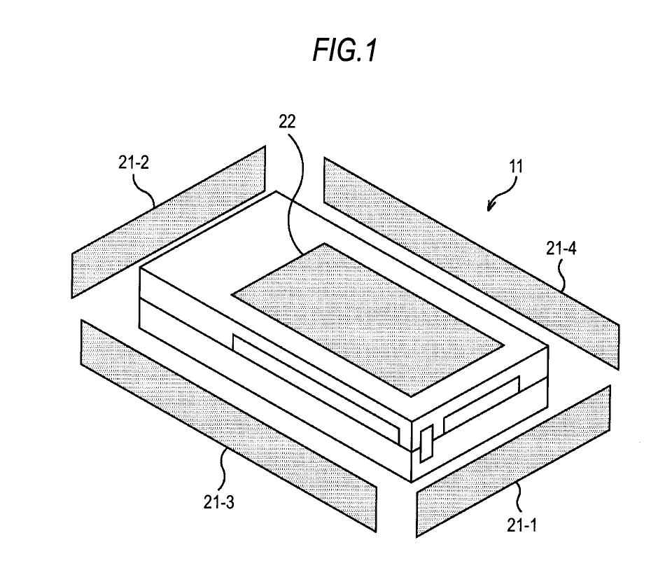

FIG. 1 is a perspective view showing an external configuration example of a mobile terminal apparatus as an information processing apparatus according to an embodiment of the present invention.

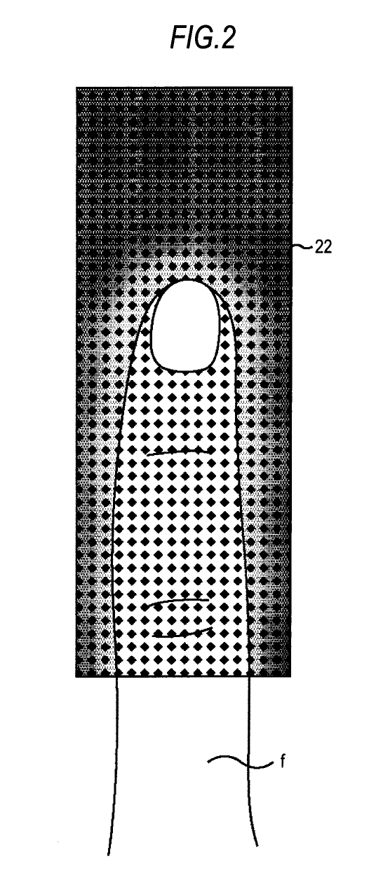

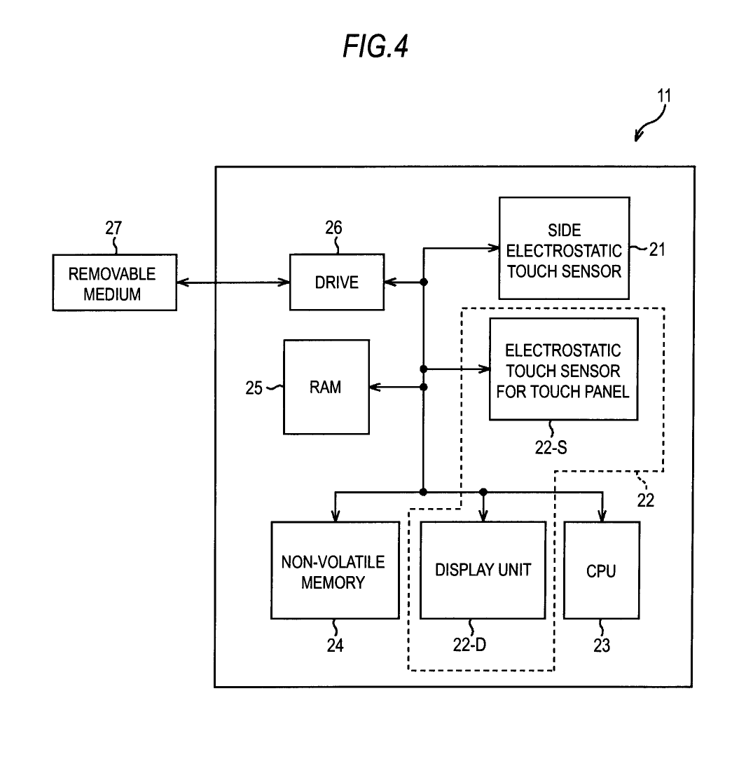

On a predetermined face of the mobile terminal apparatus 11, an electrostatic touch panel 22 is disposed. The electrostatic touch panel 22 is configured by stacking an electrostatic touch sensor 22-S for a touch panel, to be described later, shown in FIG. 4 on a display unit 22-D, to be described later, shown in FIG. 4. When a user's finger or the like is brought into contact with the screen of the display unit 22-D of the electrostatic touch panel 22, the contact is detected in the form of a change in the electrostatic capacitance of the electrostatic touch sensor 22-S for a touch panel. Then, a transition (temporal transition) of the coordinates of the contact position of the finger that is detected by the electrostatic touch sensor 22-S for a touch panel and the like are recognized by a CPU 23, to be described later, shown in FIG. 4. Then, a gesture operation is detected based on the result of recognition. A concrete example of the gesture operation and the detection technique thereof will be described later with reference to FIG. 2 and thereafter.

Hereinafter, of the faces configuring the mobile terminal apparatus 11, a face on which the display unit 22-D is disposed is referred to as a front face, and a face having a normal line perpendicular to the normal line of the front face is referred to as a side face. In the example shown in FIG. 1, there are four faces as the side faces. Hereinafter, the direction of default screen display of the electrostatic touch panel 22 (the display unit 22-D) is used as a reference, and side faces disposed on the upper side, the lower side, the right side, and the left side with respect to the front face are referred to as an upper face, a lower face, a right face, and a left face.

In the mobile terminal apparatus 11, a side electrostatic touch sensor 21-1 arranged on the upper face, and a side electrostatic touch sensor 21-2 arranged on the lower face are disposed. In addition, in the mobile terminal apparatus 11, a side electrostatic touch sensor 21-3 arranged on the right face, and a side electrostatic touch sensor 21-4 arranged on the left face are disposed.

Hereinafter, in a case where the side electrostatic touch sensors 21-1 to 21-4 do not need to be individually identified, the side electrostatic touch sensors will be collectively referred to as side electrostatic touch sensors 21.

When a user's finger or the like is brought into contact with the side face of the mobile terminal apparatus 11, the contact is detected in the form of a change in the electrostatic capacitance of the electrostatic touch sensor 21. Then, a transition (temporal transition) of the coordinates of the contact position of the finger that is detected by the side electrostatic touch sensor 21 and the like are recognized by the CPU 23, to be described later, shown in FIG. 4. A gesture operation is detected based on the result of the recognition. A concrete example of the gesture operation and the detection technique thereof will be described later with reference to FIG. 2 and thereafter.

### Detection of Contact Using Electrostatic Touch Sensor

FIG. 2 is a diagram illustrating a detection technique of the electrostatic touch sensor 22-S for a touch panel that is used in the electro-static touch panel 22.

The electrostatic touch sensor 22-S for a touch panel is configured by a combination of electrostatic sensors that are disposed in a matrix shape (for example 10×7) in the display unit 22-D. The electrostatic sensor has an electrostatic capacitance value changing constantly in accordance with a change in the electrostatic capacitance. Accordingly, in a case where a contact object such as a finger is in proximity to or in contact with the electrostatic sensor, the electrostatic capacitance value of the electrostatic sensor increases. The CPU 23, to be described later, constantly monitors the electrostatic capacitance values of the electrostatic sensors. When the change in the amount of increase exceeds a threshold value, the CPU 23 determines that there is a “contact” of the finger or the like that is in proximity to or in contact with the electrostatic touch panel 22. In other words, the CPU 23 detects the coordinates of the contact position of the finger or the like based on the disposed position of the electrostatic sensor in which existence of the “contact” is determined. In other words, the CPU 23 can simultaneously monitor the electrostatic capacitance values of all the electrostatic sensors constituting the electrostatic touch sensor 22-S for a touch panel. The CPU simultaneously monitors changes in the electrostatic capacitance values of all the electrostatic sensors and performs interpolation, and thereby the position of the finger or the like that is in proximity to or in contact with the electrostatic touch panel 22, the shape of the finger, or the like can be detected by the CPU 23.

For example, in an example illustrated in FIG. 2, in the electrostatic touch panel 22, a black display area represents an area which a finger f is not in proximity to or in contact with and of which the electrostatic capacitance does not change. In addition, a white display area represents an area which a finger f is in proximity to or in contact with and of which the electrostatic capacitance increases. In such a case, the CPU 23 can recognize the coordinates of the white area as the position of the finger f and detect the shape of the white area as the shape of the finger f.

In description here, a contact includes not only a static contact (a contact only with a specific area) but also a dynamic contact (a contact made by a contact object such as a finger f moving while drawing a predetermined trajectory). For example, the finger or the like on the electrostatic touch panel 22 is also one form of the contact. Hereinafter, a contact includes not only a complete contact but also proximity.

In addition, the CPU 23 can recognize the trajectory of the finger or the like on the electrostatic touch panel 22 by detecting the contact positions of the finger or the like in a time series. In addition, the CPU 23 can perform an interaction process corresponding to a gesture operation by detecting the gesture operation corresponding to such a trajectory.

Until now, the detection technique of the electrostatic touch sensor 22-S for a touch panel that is used in the electrostatic touch panel 22 has been described. Such a detection technique is the same for the side electrostatic touch sensor 21.

In other words, the CPU 23 can perform an interaction process corresponding to a gesture operation by detecting the gesture operation for the side face of the mobile terminal apparatus 11 by monitoring a change in the electrostatic capacitance of the side electrostatic touch sensor 21.

### Example of Interaction

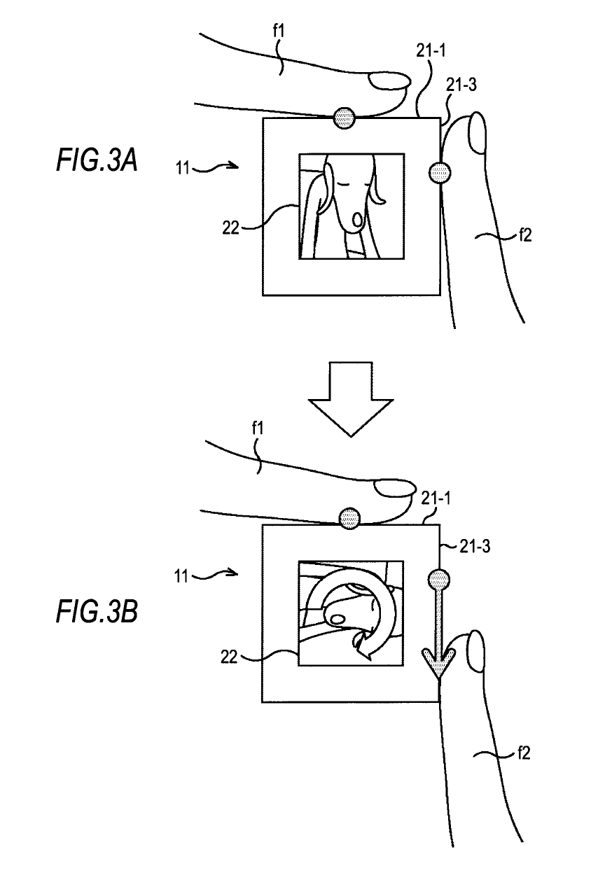

FIGS. 3A and 3B are diagrams illustrating an example of a gesture operation for the side face of the mobile terminal apparatus 11 and an interaction process corresponding to the gesture operation.

For example, it is assumed that the display state of the electrostatic touch panel 22 is a display state represented in FIG. 3A, that is, a state in which a still screen including one object (dog) is displayed on the electrostatic touch panel 22 in the default display direction. The default display direction, as described above, is a direction in which an image is displayed such that the upper face on which the side electrostatic touch sensor 21-1 is disposed is on the upper side. In addition, it is assumed that, in this state, a user's finger f1 is brought into contact with a position near the center of the upper face (the face on which the side electrostatic touch sensor 21-1 is disposed) of the mobile terminal apparatus 11, that is, a position denoted by a circle in FIG. 3A. In addition, it is assumed that a user's finger f2 is brought into contact with a position near the upper side of the right face (the face on which the side electrostatic touch sensor 21-3 is disposed) of the mobile terminal apparatus 11, that is, a position denoted by a circle in FIG. 3A.

Here, it is assumed that the user performs a gesture operation of moving the finger f2 from the state represented in FIG. 3A to the state represented in FIG. 3B. In other words, it is assumed that the user performs a tracing operation in a downward direction denoted by an arrow in FIG. 3B only with the finger f2, which is brought into contact with the side electrostatic touch sensor 21-3, with the state of the finger f1 maintained.

The tracing operation is one of the gesture operations and represents an operation of user's bringing a finger into contact with a predetermined area and then moving (dragging) the finger by a predetermined distance in a predetermined direction with the predetermined area used as a start point while the contact of the finger is maintained.

When such a downward tracing operation for the right face is performed, as represented in FIG. 3B, a process of changing the display direction of the electrostatic touch panel 22 to the direction of the tracing operation is performed as an interaction process. In other words, a process of rotating the display toward the right side by 90 degrees with respect to the default display direction (the display direction in FIG. 3A) is performed.

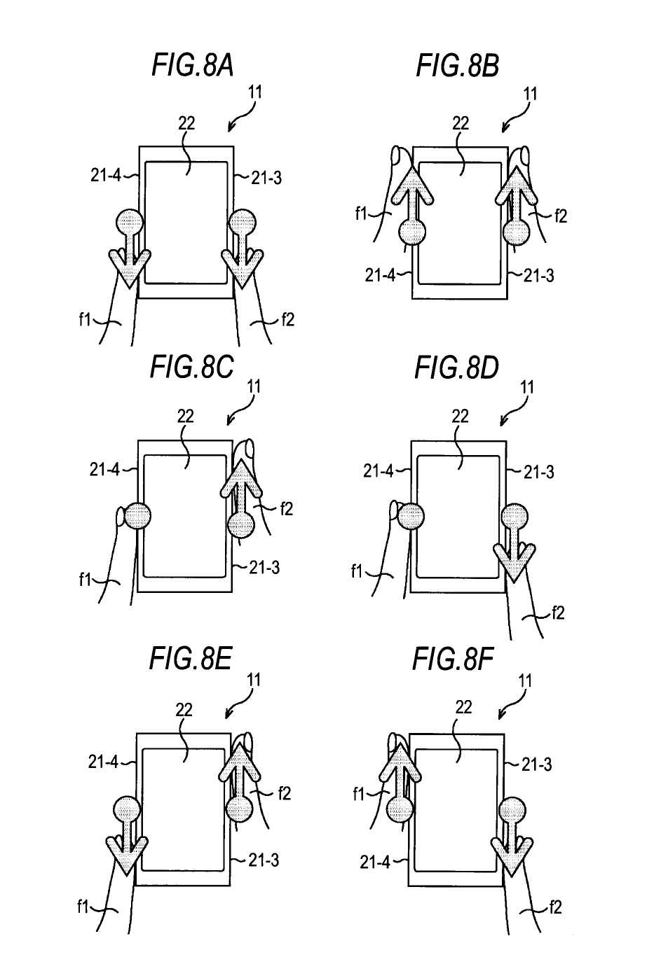

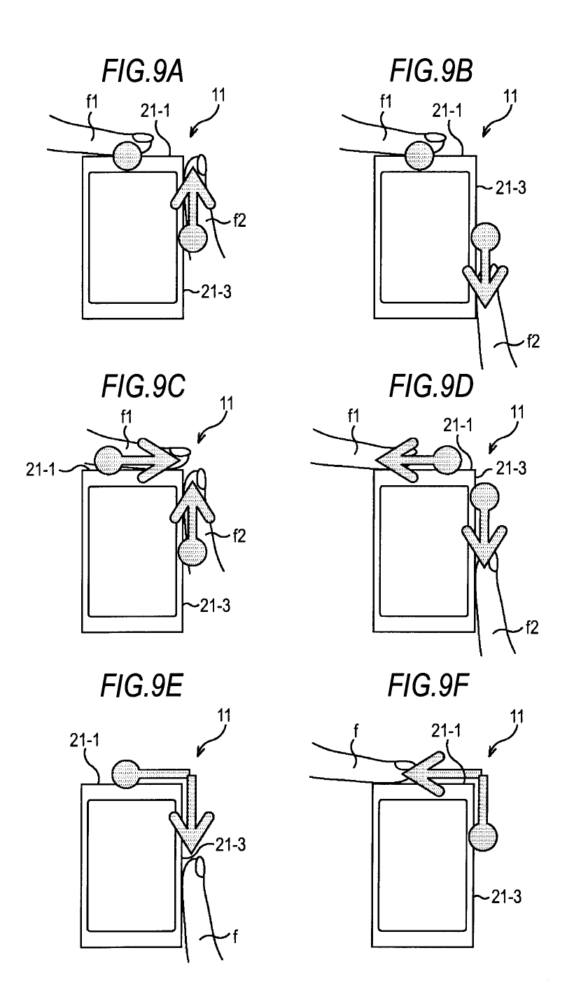

As described above, the user can perform the interaction process for the mobile terminal apparatus 11 by performing a gesture operation for the side face of the mobile terminal apparatus 11. In addition, other examples of the gesture operation and the interaction process will be described later with reference to FIGS. 8A to 8F and FIGS. 9A to 9F.

Next, a configuration example of the mobile terminal apparatus 11 that performs the above-described interaction process will be described with reference to FIG. 4.

### Configuration Example of Mobile Terminal Apparatus

FIG. 4 is a block diagram showing an internal configuration example of the mobile terminal apparatus 11 shown in FIG. 1.

The mobile terminal apparatus 11 is configured to include the CPU (Central Processing Unit) 23, a non-volatile memory 24, a RAM (Random Access Memory) 25, and a drive 26, in addition to the side electrostatic touch sensor 21 and the electrostatic touch panel 22 described above.

The electrostatic touch panel 22, as described above, is configured by the electrostatic touch sensor 22-S for a touch panel and the display unit 22-D.

The CPU 23 controls the overall operation of the mobile terminal apparatus 11. Accordingly, the side electrostatic touch panel 21, the electrostatic touch panel 22, the non-volatile memory 24, the RAM 25, and the drive 26 are connected to the CPU 23.

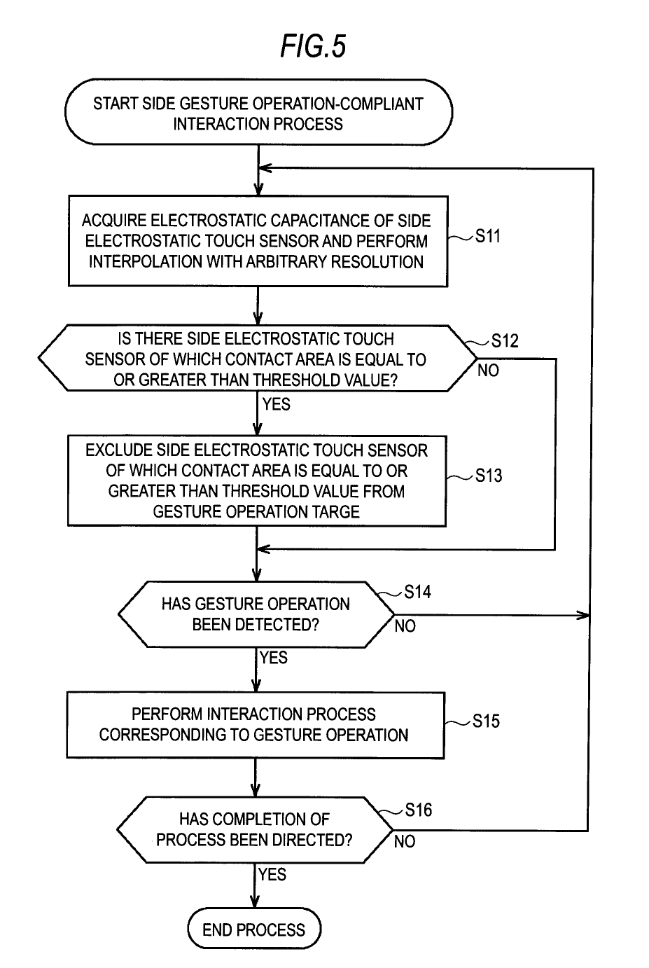

For example, the CPU 23 performs an interaction process in accordance with a gesture operation for the side face of the mobile terminal apparatus 11. In other words, the CPU 23 generates a thread (hereinafter, referred to as an electrostatic capacitance monitoring thread) that monitors changes in the electrostatic capacitance of the side electrostatic touch sensors 21-1 to 21-4. Then, the CPU 23 determines whether the user's finger f is brought into contact with the side face (the side electrostatic touch sensor 21) based on the monitoring result of the electrostatic capacitance monitoring thread. Then, when determining that the finger is brought into contact with the side face, the CPU 23 detects a predetermined gesture operation and performs an interaction process corresponding thereto. Hereinafter, such a series of processes performed by the CPU 23 is referred to as a side gesture operation-compliant interaction process. The side gesture operation-compliant interaction process will be described in detail with reference to FIG. 5 and thereafter.

The non-volatile memory 24 stores various types of information. For example, even when the state of power transits to the OFF state, information to be stored and the like are stored in the non-volatile memory 24.

The RAM 25 temporarily stores programs and data that may be needed as a work area at the time when the CPU 23 performs various processes.

The drive 26 drives a removable medium 27 such as a magnetic disk, an optical disc, a magneto-optical disk, or a semiconductor memory.

### Side Gesture Operation-Compliant Interaction Process

FIG. 5 is a flowchart illustrating an example of a side gesture operation-compliant interaction process of the mobile terminal apparatus 11 having the above-described configuration.

In Step S11, the CPU 23 acquires the electrostatic capacitance of the side electrostatic touch sensor 21 and performs interpolation for the electrostatic capacitance with arbitrary resolution. In other words, at the start time point of the side gesture operation-compliant interaction process, the CPU 23 generates an electrostatic capacitance monitoring thread, as described above. The CPU 23 acquires the electrostatic capacitance of the side electrostatic touch sensor 21 through the electrostatic capacitance monitoring thread, calculates a difference between the acquired electrostatic capacitance and electrostatic capacitance at the time of generation of the thread, and performs interpolation with arbitrary resolution.

In Step S12, the CPU 23 determines whether or not there is a side electrostatic touch sensor 21 of which the contact area is equal to or greater than a threshold value (for example, 30% of the area of the side electrostatic touch sensor 21).

In a case where there is one or more side electrostatic touch sensors 21, of which the contact area is equal to or greater than the threshold value, out of the four side electrostatic touch sensors 21-1 to 21-4, “YES” is determined in Step S12, and the process proceeds to Step S13.

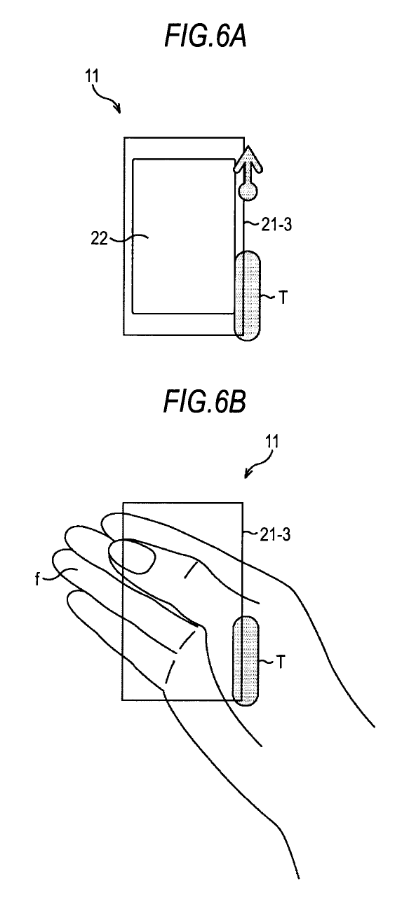

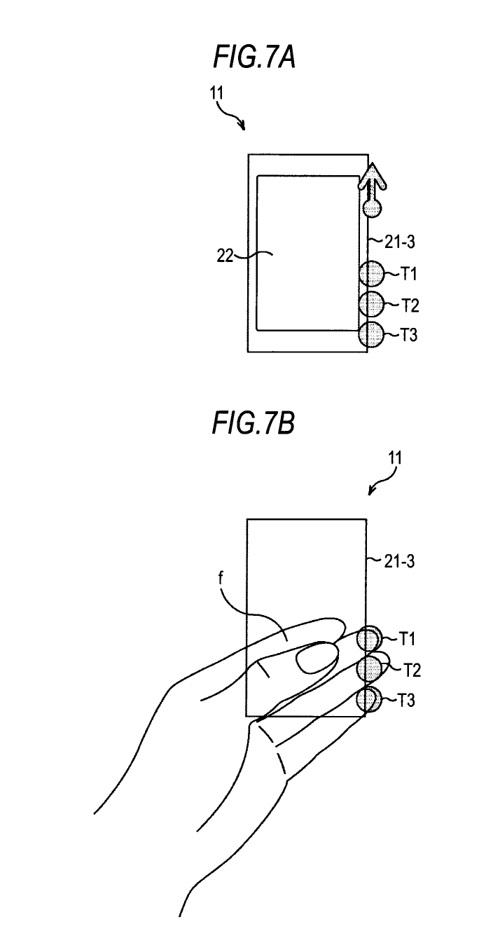

In Step S13, the CPU 23 excludes the side electrostatic touch sensor 21 of which the contact area is equal to or greater than the threshold value from the gesture operation target. In other words, although details thereof will be described later with reference to FIGS. 6A and 6B and 7A and 7B, the side electrostatic touch sensor 21 of which the contact area is equal to or greater than the threshold value is assumed to be brought into contact with a finger or a palm of the user in order to grip the side face on which the side electrostatic touch sensor 21 is disposed. Thus, the CPU 23 prohibits detection of a gesture operation from such a side electrostatic touch sensor 21. Accordingly, the process proceeds to Step S14.

On the other hand, in a case where there is no side electrostatic touch sensor 21 of which the contact area of the finger is equal to or greater than the threshold value, there is no side electrostatic touch sensor 21 from which the detection of a gesture operation is prohibited. Accordingly, “NO” is determined in Step S12. Then, the process of Step S13 is not processed, and the process proceeds to Step S14.

In Step S14, the CPU 23 determines whether a gesture operation has been detected.

In a case where the gesture operation is not detected from all the side electrostatic touch sensors 21 from which the detection of a gesture operation is not prohibited, “NO” is determined in Step S14. Then, the process is returned back to Step S11, and the process thereafter is repeated. In other words, until a gesture operation is detected, a looping process of Steps S11 to S14 is repeated.

Thereafter, in a case where a gesture operation is detected from at least one of the side electrostatic touch sensors 21 from which the detection of a gesture operation is not prohibited, “YES” is determined in Step S14, and the process proceeds to Step S15.

In Step S15, the CPU 23 performs an interaction process corresponding to the gesture operation.

In Step S16, the CPU 23 determines whether completion of the process has been directed.

In a case where completion of the process has not been directed, “NO” is determined in Step S16, and the process is returned back to Step S11. Then, the process thereafter is repeated.

On the other hand, in a case where the completion of the process has been directed, “YES” is determined in Step S11, and the side gesture operation-compliant interaction process is completed.

### Prevention of Incorrect Detection of Gesture Operation

Hereinafter, of the side gesture operation-compliant interaction process, the process of Steps S12 and S13 will be described in detail.

On the side faces of the mobile terminal apparatus 11 of this embodiment, the side electro-static touch sensors 21 are disposed. Thus, in a case where the side face of the mobile terminal apparatus 11 is gripped so as to perform a gesture operation by a finger, a palm, or the like of the user, the finger, the palm, or the like is brought into contact with the side electrostatic touch sensor 21 for the gripping. Even in such a case, the CPU 23 detects a contact. However, in a case where such a contact is incorrectly detected as a predetermined gesture operation, a wrong interaction process is performed.

Thus, in order to avoid such an incorrect detection, the process of Steps S12 and S13 is performed for the side gesture operation-compliant interaction process. Hereinafter, the process of Steps S12 and S13 will be referred to as an incorrect gesture operation detection preventing process.

FIGS. 6A and 6B and FIGS. 7A and 7B are diagrams illustrating the incorrect gesture operation detection preventing process.

For example, it is assumed that a contact is detected from an area T (gray oval area T) of the side electrostatic touch sensor 21-3 shown in FIG. 6A. The area T from which a contact that lasts for a predetermined time or longer is detected corresponds to the contact area described in Steps S12 and S13.

Thus, in a case where the contact area of the area T is equal to or greater than the threshold value, the contact with the side electrostatic touch sensor 21-3 can be assumed not to be a contact for a gesture operation but to be a contact for gripping the mobile terminal apparatus 11. In other words, as shown in FIG. 6B, a state is assumed in which the user has the right hand to be in equal contact with the right face, on which the side electrostatic touch sensor 21-3 is disposed, for gripping the mobile terminal apparatus 11 with the right hand. In other words, a state is assumed in which the user performs a gesture operation or a preparatory operation thereof for a side face other than the right face. The threshold value of the contact area can be arbitrarily set. For example, the threshold value can be set to 30% of the area of the side electrostatic touch sensor 21.

In such a case, “YES” is determined in the process of Step S12 represented in FIG. 5. Accordingly, in the process of Step S13, the side electrostatic touch sensor 21-3 is excluded from the detection target of the gesture operation in the process of Step S14 that is in the latter stage. In other words, even in a case where the user performs a gesture operation with a finger or the like other than the gripping finger for the side electrostatic touch sensor 21-3, the gesture operation has no effect.

Meanwhile, it is assumed that contacts are detected from, for example, areas T1, T2, and T3 (gray circular areas T1, T2, and T3) of the side electrostatic touch sensor 21-3 shown in FIG. 7A. In each of areas T1, T2, and T3, the area in which a contact lasting for a predetermined time or longer corresponds to the contact area described in Steps S12 and S13.

Thus, in a case where all the contact areas of the areas T1, T2, and T3 respectively are smaller than the threshold value, the contact with the side electrostatic touch sensor 21-3 can be assumed not to be a contact for gripping the mobile terminal apparatus 11. In other words, the contact with the side electrostatic touch sensor 21-3 can be assumed to be a contact for a gesture operation or a preparatory contact thereof. In other words, a state can be assumed in which, as shown in FIG. 7B, the user has the palm of the left hand in contact with the left face for gripping the mobile terminal apparatus 11 with the left hand. In other words, a state can be assumed in which the user performs a gesture operation or a preparatory operation thereof for a side face other than the left face. In other words, the right face on which the side electrostatic touch sensor 21-3 is disposed is assumed to be a side face that can be a target for a user's gesture operation. The point is that whether the contacts with the areas T1, T2, and T3 are contacts for a gesture operation or an auxiliary contact for gripping the mobile terminal apparatus 11 is determined as an assumption.

In such a case, that is, in a case where the contact area of each side electrostatic touch sensor 21 disposed on all the side faces including the right face side is smaller than the threshold value, “NO” is determined in the process of Step S12 represented in FIG. 5. Then, the process of Step S13 is not performed, and the process proceeds to Step S14. Accordingly, the side electrostatic touch sensor 21-3 becomes a detection target for a gesture operation in the process of Step S14. In other words, in a case where the user performs a gesture operation for the side electrostatic touch sensor 21-3, the gesture operation is effective.

As described above, the mobile terminal apparatus 11 performs the incorrect gesture operation detection preventing process. Accordingly, for example, even in a case where the user simultaneously performs a gripping operation for the mobile terminal apparatus 11 and a gesture operation with one hand, incorrect detection of the gesture operation can be prevented. As a result, the user can perform a gesture operation for a side face of the mobile terminal apparatus 11 only with one hand.

Next, a concrete example of the interaction process performed in Step S15 of the side gesture operation-compliant interaction process will be described with reference to FIGS. 8A to 8F and FIGS. 9A to 9F.

### Concrete Examples of Interaction Process

FIGS. 8A to 8F and FIGS. 9A to 9F are diagrams illustrating concrete examples of the interaction process of the mobile terminal apparatus 11.

In the examples of FIG. 8A to 8F, the user performs a gesture operation for two side faces of the mobile terminal apparatus 11 that face each other.

FIGS. 8A and 8B represent a gesture operation of simultaneously performing tracing operations for the right face and the left face of the mobile terminal apparatus 11 in a same direction.

In the example of FIG. 8A, as a gesture operation, downward tracing operations for the right face and the left face of the mobile terminal apparatus 11 are performed. In other words, the user performs simultaneous downward tracing operations with the fingers f2 and f1 that are brought into contact with the side electrostatic touch sensors 21-3 and 21-4. As a result, the CPU 23 performs the following interaction process. The CPU 23 moves a display image to the lower side at a higher speed, compared to a case where an ordinary scroll operation is performed for the electrostatic touch panel 22.

In the example of FIG. 8B, as a gesture operation, upward tracing operations for the right face and the left face of the mobile terminal apparatus 11 are performed. In other words, the user performs simultaneous upward tracing operations with the fingers f2 and f1 that are brought into contact with the side electrostatic touch sensors 21-3 and 21-4. As a result, the CPU 23 performs the following interaction process. The CPU 23 moves a display image to the upper side at a higher speed, compared to a case where an ordinary scroll operation is performed for the electrostatic touch panel 22.

In the examples of FIGS. 8A and 8B, a case where it is difficult to acquire affordance can be considered. In such a case, by reducing the object displayed in the display unit 22-D or the like for displaying a bird's eye view, an increase in the moving speed of the display image according to the gesture operation can be visually represented.

FIGS. 8C and 8D represent a gesture operation in which a tracing operation for the right face is performed upwardly or downwardly while a predetermined position on the left face of the mobile terminal apparatus 11 is in a contact state.

In the example of FIG. 8C, as a gesture operation, an upward tracing operation is performed for the right face while a predetermined position on the left face of the mobile terminal apparatus 11 is in a contacted state. In other words, the user performs an upward tracing operation with the finger f2 that is brought into contact with the side electrostatic touch sensor 21-3 while allowing a predetermined position on the side electrostatic touch sensor 21-4 to be in contact with the finger f1. As a result, the CPU 23 performs the following interaction process. The CPU 23 moves a display image to the upper side, similarly to a case where an ordinary upward scroll operation is performed for the electrostatic touch panel 22.

In the example of FIG. 8D, as a gesture operation, a downward tracing operation is performed for the right face while a predetermined position on the left face of the mobile terminal apparatus 11 is in a contacted state. In other words, the user performs a downward tracing operation with the finger f2 that is brought into contact with the side electrostatic touch sensor 21-3 while allowing a predetermined position on the side electrostatic touch sensor 21-4 to be in contact with the finger f1. As a result, the CPU 23 performs the following interaction process. The CPU 23 moves a display image to the lower side, similarly to a case where an ordinary downward scroll operation is performed for the electrostatic touch panel 22.

The reason for allowing the left face to be in contact with the finger f1 for performing the upward tracing operation for the right face side is to avoid an incorrect operation for a case where only the right face is scrolled.

FIGS. 8E and 8F represent gesture operations in which tracing operations are simultaneously performed for the left face and the right face of the mobile terminal apparatus 11 in opposite directions.

In the example of FIG. 8E, as a gesture operation, tracing operations for the right face and the left face of the mobile terminal apparatus 11 are performed in opposite directions. In other words, the user performs an upward tracing operation with the finger f2 that is brought into contact with the side electrostatic touch sensor 21-3 simultaneously with performing a downward tracing operation with the finger f1 that is brought into contact with the side electrostatic touch sensor 21-4. As a result, the CPU 23 performs the following interaction process. The CPU 23 enlarges or reduces a display image.

In the example of FIG. 8F, as a gesture operation, tracing operations for the right face and the left face of the mobile terminal apparatus 11 are performed in opposite directions. In other words, the user performs a downward tracing operation with the finger f2 that is brought into contact with the side electrostatic touch sensor 21-3 simultaneously with performing an upward tracing operation with the finger f1 that is brought into contact with the side electrostatic touch sensor 21-4. As a result, the CPU 23 performs the following interaction process. The CPU 23 reduces or enlarges a display image.

In the examples of FIGS. 8A to 8F, gesture operations performed for the side electrostatic touch sensors 21-3 and 21-4 positioned on the left face and the right face, as the side electrostatic touch sensors 21 positioned on two side faces of the mobile terminal apparatus 11 that oppose each other, have been described. However, the side electrostatic touch sensors 21-1 and 21-2 positioned on the upper face and the lower face, as the two side faces of the mobile terminal apparatus 11 that face each other, may be used. In a case where the upper face and the lower face are used, when a rightward tracing operation is performed, similarly to a case where an ordinary rightward scroll operation is performed, a display image is moved to the right side. In addition, in a case where a leftward tracing operation is performed, similarly to a case where an ordinary leftward scroll operation is performed, a display image is moved to the left side.

In the examples represented in FIGS. 9A to 9F, a gesture operation is performed for the side electrostatic touch sensors 21-1 and 21-3 that are positioned on two side faces of the mobile terminal apparatus 11 that are adjacent to each other.

FIGS. 9A and 9B represent gesture operations in which an upward or downward tracing operation is performed for the right face while a predetermined position on the upper face of the mobile terminal apparatus 11 is in a contacted state.

In the example of FIG. 9A, as a gesture operation, an upward tracing operation is performed for the right face while a predetermined position on the upper face of the mobile terminal apparatus 11 is in a contact state. In other words, the user performs an upward tracing operation with the finger f2 that is brought into contact with the side electrostatic touch sensor 21-3 while allowing the finger f1 to be in contact with a predetermined position on the side electrostatic touch sensor 21-1. As a result, the CPU 23 performs the following interaction process. The CPU 23 rotates a display image in the direction of the upward tracing operation. In such a case, a process of rotating the display image by 90 degrees to the left side with respect to the default display direction in which the image is displayed such that the upper face on which the side electrostatic touch sensor 21-1 is disposed is positioned on the upper side is performed.

In the example of FIG. 9B, as a gesture operation, a downward tracing operation is performed for the right face while a predetermined position on the upper face of the mobile terminal apparatus 11 is in a contacted state. In other words, the user performs a downward tracing operation with the finger f2 that is brought into contact with the side electrostatic touch sensor 21-3 while allowing the finger f1 to be in contact with a predetermined position on the side electrostatic touch sensor 21-1. As a result, the CPU 23 performs the following interaction process. The CPU 23 rotates the display image in the direction of the tracing operation. In such a case, a process of rotating the display image by 90 degrees to the right side with respect to the default display direction is performed.

FIGS. 9C and 9D represent gesture operations in which tracing operations are simultaneously performed in a direction in which the upper face and the right face of the mobile terminal apparatus 11 approach each other or are separated away from each other.

In the example of FIG. 9C, as a gesture operation, a gesture operation in which tracing operations are simultaneously performed in a direction in which the fingers f1 and f2 that are brought into contact with the upper face and the right face of the mobile terminal apparatus 11 are adjacent to each other is represented. In other words, the user performs an upward tracing operation with the finger f2 that is brought into contact with the side electrostatic touch sensor 21-3 simultaneously with performing a rightward tracing operation with the finger f1 that is brought into contact with the side electrostatic touch sensor 21-1. As a result, the CPU 23 performs the following interaction process. The CPU 23 moves a display image to the right upper side until the finger f1 or f2 is not in contact with the side electrostatic touch sensor 21.

In the example of FIG. 9D, as a gesture operation, a gesture operation in which tracing operations are simultaneously performed in a direction in which the fingers f1 and f2 are brought into contact with the upper face and the right face of the mobile terminal apparatus 11 are separated away from each other is represented. In other words, the user performs a downward tracing operation with the finger f2 that is brought into contact with the side electrostatic touch sensor 21-3 simultaneously with a leftward tracing operation with the finger f1 that is brought into contact with the side electrostatic touch sensor 21-1. As a result, the CPU 23 performs the following interaction process. The CPU 23 moves the display image in the left lower side until the finger f1 or f2 is not in contact with the side electrostatic touch sensor 21.

FIGS. 9E and 9F represent gesture operations in which tracing operations are continuously performed from the upper face or the right face of the mobile terminal apparatus 11 to the right face side or the upper face thereof.

In the example of FIG. 9E, as a gesture operation, a continuous tracing operation with the finger f that is brought into contact with the upper face of the mobile terminal apparatus 11 to the right face is performed. In other words, the user performs a rightward tracing operation with the finger f that is brought into contact with the side electrostatic touch sensor 21-1 and then immediately performs a downward tracing operation for the side electrostatic touch sensor 21-3. As a result, the CPU 23 performs the following interaction process. The CPU 23 moves the display from display of an image of the current page to display of an image of the next page or the previous page.

In the example of FIG. 9F, as a gesture operation, a continuous tracing operation with the finger f that is brought into contact with the right face of the mobile terminal apparatus 11 to the upper face is performed. In other words, the user performs an upward tracing operation with the finger f that is brought into contact with the side electrostatic touch sensor 21-3 and then immediately performs a leftward tracing operation for the side electrostatic touch sensor 21-1. As a result, the CPU 23 performs the following interaction process. The CPU 23 moves the display from display of an image of the current page to display of an image of the next page or the previous page.

In addition, in the examples of FIGS. 9E and 9F, there is a case where the side electrostatic touch sensors 21 positioned on two adjacent side faces are not one continuous touch sensor. In such a case, for example, the interaction process may be performed as follows. In a case where a tracing operation is performed from one side face to the other side face adjacent thereto, when a tracing operation for the other side face is performed within a predetermined time from a tracing operation for the one side face, the tracing operations may be considered as a continuous tracing operation. In such a case, the interaction process is performed.

In the examples of FIGS. 9A to 9F, the gesture operations for the side electrostatic touch sensors 21-1 and 21-3 disposed on the upper face and the right face as the side electrostatic touch sensors 21 positioned on two adjacent side faces of the mobile terminal apparatus 11 have been described. However, side faces to be used are not particularly limited as long as the side faces are two adjacent side faces of the mobile terminal apparatus 11.

As described above, by disposing a plurality of the side electrostatic touch sensors 21 on the side faces of the mobile terminal apparatus 11, a gesture operation can be performed even for a mobile terminal apparatus 11 for which it is difficult to acquire a predetermined area or shape of the electrostatic touch panel 22.

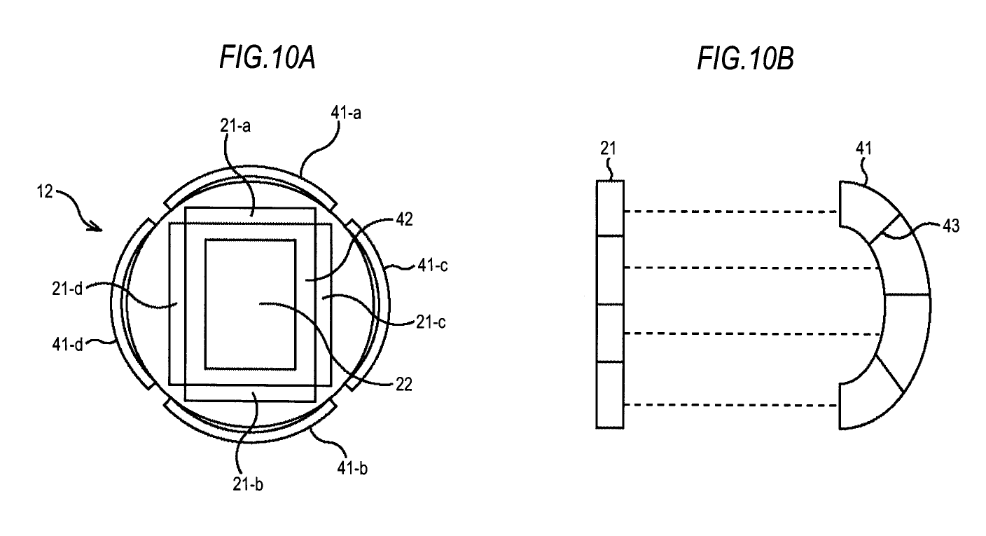

In addition, by disposing the side electrostatic touch sensors 21 on the side faces of the mobile terminal apparatus 11, the shape of each side face of the mobile terminal apparatus 11 can be freely changed. Hereinafter, the shape of the side face of the mobile terminal apparatus 11 will be described with reference to FIGS. 10A and 10B.

In the mobile terminal apparatus 11, the side electrostatic touch sensor 21 and the electrostatic touch sensor 22-S for a touch panel are employed.

However, the electrostatic touch sensor 22-S for a touch panel is stacked on the display unit 22-D and configures the electrostatic touch panel 22. Accordingly, in order not to disturb the display in the display unit 22-D, a transparent electrostatic touch sensor may need to be employed as the electrostatic touch sensor 22-S for a touch panel.

On the other hand, since the side electrostatic touch sensor 21 is disposed on the side face of the mobile terminal apparatus 11, a transparent electrostatic touch sensor does not need to be particularly employed. Accordingly, by combining the side electrostatic touch sensor 21 and a conductive material, of which the shape can be freely changed, together, the shape of the side face of the mobile terminal apparatus 11 can be freely formed.

### Another External Configuration Example of Information Processing Apparatus according to Embodiment of Present Invention

For example, FIGS. 10A and 10B represent an external configuration example of a mobile terminal apparatus as an information processing apparatus according to another embodiment of the present invention. FIGS. 10A and 10B are diagrams showing another example that is different from the example of FIG. 1.

As shown in FIG. 10A, for example, the mobile terminal apparatus 12 has side faces having a curved shape and has a configuration in which a right-angled parallelepiped main body portion 42 is disposed on its center. On the front face of the main body portion 42, an electrostatic touch panel 22 is disposed.

In the main body portion 42 of the mobile terminal apparatus 12, a side electrostatic touch sensor 21-a disposed on an upper face and a side electrostatic touch sensor 21-b disposed on a lower face are disposed. In addition, in the main body portion 42 of the mobile terminal apparatus 12, a side electrostatic touch sensor 21-c disposed on a right face and a side electrostatic touch sensor 21-d disposed on a left face are disposed.

On the side face of the mobile terminal apparatus 12, conductive materials 41-a to 41-d formed of aluminum having a curved shape along the side face (curved face) are disposed.

In addition, the conductive materials 41-a to 41-d are combined with the side electrostatic touch sensors 21-a to 21-d.

Hereinafter, in a case where the side electrostatic touch sensors 21-a to 21-d do not need to be individually identified, the side electrostatic touch sensors will be collectively referred to as the side electrostatic touch sensors 21. Similarly, in a case where the conductive materials 41a to 41d do not need to be individually identified, the conductive materials will be collectively referred to as the conductive materials 41.

In particular, for example, as shown in FIG. 10B, a conductive material 41 made of aluminum or the like is combined with the side electrostatic touch sensor 21. The side electrostatic touch sensor 21 can detect a change in the electrostatic capacitance due to a contact of a finger or the like even through the conductive material 41. Accordingly, the shape of the conductive material 41 that is combined with the side electrostatic touch sensor 21 can be freely changed. In other words, since the shape of the conductive material 41 can be adjusted to the shape of the side face of the information processing apparatus according to an embodiment of the present invention, the side face of the information processing apparatus according to the embodiment can be formed in an arbitrary shape. In the example shown in FIGS. 10A and 10B, the shape of the side face of the mobile terminal apparatus 11 is a curved face. Accordingly, the conductive material 41 has a curved shape corresponding to the curved face.

In addition, as shown in FIG. 10B, the conductive material 41 is divided into parts corresponding to the number of electrostatic sensors configuring the side electrostatic touch sensor 21. Between the divided conductive materials 41, a non-conductive material 43 is disposed. In other words, a change in the electrostatic capacitance due to a contact of a finger or the like with the conductive material 41 uniformly propagates inside the conductive material 41. Thus, in a case where spaces between the conductive materials 41 are not delimited by the non-conductive material 43, it is difficult to precisely detect a change in the electrostatic capacitance by using the side electrostatic touch sensor 21. Accordingly, the conductive materials 41 are delimited by the non-conductive materials 43 in correspondence with the number of the electrostatic sensors configuring the side electrostatic touch sensor 21. Accordingly, the change in the electrostatic capacitance propagates only to an area (an electrostatic sensor responsible for the area) of the side electrostatic touch sensor 21 corresponding to a position on a contact face of the conductive material 41 for which the contact of a finger or the like is made.

For easy understanding of embodiments of the present invention, a case where a set of a plurality of electrostatic sensors is configured as the side electrostatic touch sensor 21, and the conductive materials 41 are combined with the side electrostatic touch sensors 21 has been described as above. However, the side electrostatic touch sensor 21 may be configured by a plurality of electrostatic sensors and conductive materials 41 combined with the electrostatic sensors.

Furthermore, an information processing apparatus according to an embodiment of the present invention is not limited to the above-described examples and may have various forms.

For example, in the above-described example, it is premised that a gesture operation that is performed in a place other than the electrostatic touch panel 22 is performed for the side faces of the mobile terminal apparatuses 11 and 12. Accordingly, the side electrostatic touch sensors 21 are disposed on the side faces. However, a place for the gesture operation other than the electrostatic touch panel 22, as is described as “other than the electrostatic touch panel 22, may be any place other than the electrostatic touch panel 22. In other words, an information processing apparatus according to an embodiment of the present invention may have a configuration in which the electrostatic touch sensor is disposed in a place other than the electrostatic touch panel 22 in which a gesture operation can be performed.

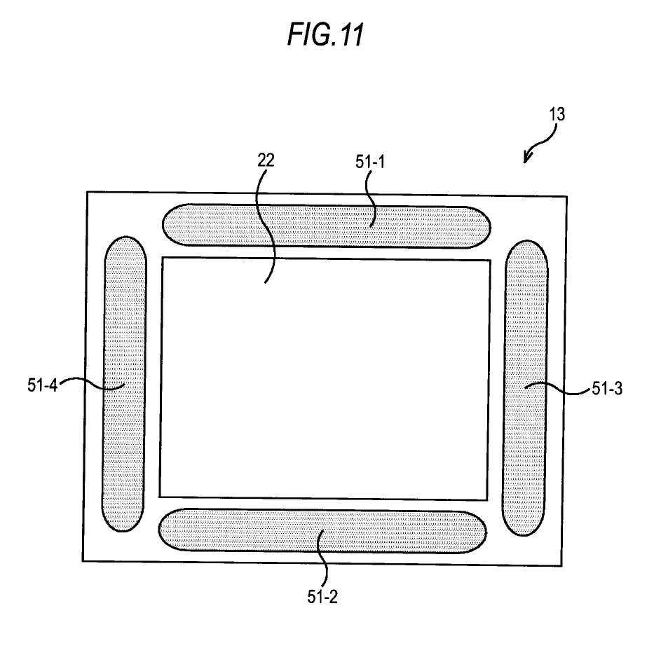

For example, FIG. 11 is an external configuration example of a mobile terminal apparatus as an information processing apparatus according to an embodiment of the present invention. FIG. 11 is a diagram showing another example that is different from the examples of FIG. 1 and FIGS. 10A and 10B.

In the example of FIG. 11, in areas located on the front face of the mobile terminal apparatus 13 other than the area in which the electrostatic touch panel 22 is disposed, electrostatic touch sensors 51-1 to 51-4 are disposed.

In addition, as a sensor that detects a gesture operation, an electrostatic touch sensor is used in the above-described examples. Described in more detail, in an information processing apparatus according to an embodiment of the present invention, a touch panel or a display unit are not essential elements. In other words, the present invention can be applied to an information processing apparatus having an area in which a gesture operation can be performed. For example, the present invention can be applied to a headphone as well. The reason is that, in a portion of the headphone in which an ear is placed, a gesture operation can be performed.

The above-described series of processes may be performed by hardware or software. In a case where the series of processes is performed by software, a program configuring the software is installed to a computer. Here, the computer includes a computer that is built in dedicated hardware and a computer that can perform various functions by installing various programs, for example, a general-purpose personal computer, and the like.

For example, the series of processes may be performed by a computer that controls the mobile terminal apparatus 11 shown in FIG. 4.

In FIG. 4, the CPU 23 performs the above-described series of processes by loading a program, for example, stored in the non-volatile memory 24 into the RAM 25 and executing the program.

The program executed by the CPU 23, for example, may be provided by being recorded on a removable medium 27 as a package medium or the like. In addition, the program may be provided through a wired or wireless transmission medium such as a local area network, the Internet, or a digital satellite broadcast.

The program can be installed to the non-volatile memory 24 by loading the removable medium 27 into the drive 26.

In addition, the program executed by the computer may be a program that performs processes in a time series in the described order, a program that performs the processes in parallel to one another, or a program that performs the processes at a necessary time such as a time when the process is called.

The present application contains subject matter related to that disclosed in Japanese Priority Patent Application JP 2009-114196 filed in the Japan Patent Office on May 11, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
display means for displaying an image;
detection means that is disposed in an area other than another area, in which the display means is disposed, for detecting a contact in the area; and
control means for recognizing the content of an operation based on a combination of two or more contact positions in which the contact is detected by the detection means and controlling performing of a process corresponding to the content of the operation.

2. The information processing apparatus according to claim 1, wherein a plurality of the detection means that are disposed in different areas are included.

3. The information processing apparatus according to claim 1, wherein the control means recognizes the area of a contact area, in which the contact is detected, out of the area in which the detection means is disposed and switches between permission of performance and prohibition of performance for control of the recognizing of the content of the operation based on the area.

4. The information processing apparatus according to claim 3,
wherein the control means assumes the contact detected by the detection means to be for the purpose of user's gripping the information processing apparatus and controls to prohibit the performing of recognizing the content of the operation in a case where the area is equal to or greater than a threshold value, and
wherein the control means assumes the contact detected by the detection means to be for the purpose of a user's predetermined operation and controls to permit the performing of recognizing the content of the operation for the predetermined operation in a case where the area is smaller than the threshold value.

5. The information processing apparatus according to claim 1, wherein the detection means has an electrostatic sensor that outputs a change in electrostatic capacitance due to a contact and a conductive material that is combined with the electrostatic sensor and has a variable shape.

6. An information processing method comprising the step of:
recognizing the content of an operation based on a combination of two or more contact positions in which a contact is detected by detection means and controlling performing of a process corresponding to the content of the operation by using an information processing apparatus that includes display means for displaying an image and the detection means that is disposed in an area other than another area, in which the display means is disposed, for detecting the contact in the area.

7. An information processing apparatus comprising:
a display unit configured to display an image;
a detection unit that is disposed in an area other than another area, in which the display means is disposed, and configured to detect a contact in the area; and
a control unit configured to recognize the content of an operation based on a combination of two or more contact positions in which the contact is detected by the detection unit and controlling performing of a process corresponding to the content of the operation.
